(19) United States
(12) Patent Application Publication
(10) Pub. No.: US 2001/0049243 A1
(43) Pub. Date: Dec. 6, 2001

(54) Lightweight, high strength coated fabric

(76) Inventors: Earl T. Crouch, Greensboro, NC (US); Michael D. Bertolucci, Powder Springs, GA (US); Keith N. Gray, Marietta, GA (US)

Correspondence Address: RHODES & MASON, P.L.L.C., P.O. BOX 2974, GREENSBORO, NC, 27402, US

(21) Appl. No.: 09/781,752

(22) Filed: Feb. 12, 2001

Related U.S. Application Data
(63) Continuation-in-part of application No. 09/094,170, filed on Jun. 9, 1998, now abandoned.
Application No. 09/094,170 is a continuation-in-part of application No. 08/536,167, filed on Sep. 29, 1995, now Pat. No. 5,763,330.

(51) Int. Cl. B32B 5/18; B32B 5/22; D03D 15/00; D03D 25/00

(52) U.S. Cl. 442/76; 442/181

(57) ABSTRACT

A lightweight coated fabric substrate of high tenacity yams, such as nylon, polyester, polypropylene or the like is extrusion coated with a material resulting in a substantially air impermeable fabric with a tear strength-to-weight ratio of at least 8 pounds/oz. per sq. yd. at weights of between 2 and 7.5 oz. per sq. yd.

### CROSS REFERENCE TO RELATED APPLICATION

The present invention is a continuation-in-part of co-pending application Ser. No. 09/094170, filed Jun. 9, 1998 which, in turn, is a continuation-in-part of application Ser. No. 08/536167 filed Sep. 29, 1995 now U.S. Pat. No. 5,763,330, issued Jun. 9, 1998.

### BACKGROUND OF THE INVENTION

(1) Field of the Invention

The present invention relates generally to air impermeable fabrics and, more particularly to fabrics that contain high tenacity yarns, such as nylon, polyester and the like which fabrics are extrusion coated with a thermoplastic material to make them air impermeable for use, for example, as an airbag fabric.

(2) Description of the Prior Art

Extrusion coating has been used primarily in the packaging industry. For example, juice boxes and milk and cream containers account for about 80% of the extrusion coating business. In addition to extrusion coating of packaging materials, extrusion coatings have also been used to provide antiseptic containers for medical liquids, carpet backing, and cleanable wall coatings.

Air impermeable fabrics, such as are used for airbags, are presently made from nylon and other polymeric fibers. The fabrics are conventionally coated with a variety of polymeric solvent coatings to make them air impermeable. There are many problems associated with solvent coating, not the least of which are the environmental hazards associated with the solvent itself. Another environmental problem is the difficulty in recycling solvent-coated products. In addition to these problems, solvent coating, such as conventional knife over roll coating systems, normally operate at limited speeds due to the drying requirements (5 to 30 yds./min). In addition, the costs of the resin system used in the solvent coating process ranges between $4-8 per pound.

An extrusion coating process, on the other hand, such as used by the packaging industry, may operate at up to 400 yards a minute with a cost of $ 1-2 per pound for the thermoplastic coating materials. Also, in addition to environmental costs, recyclability, and speed considerations, thermoplastic extrusion coatings theoretically are mechanically stronger than rubber-based solvent coatings such as are conventionally used to produce air impermeable airbag fabrics. Accordingly, such coatings allow use of lower denier fabrics or a less dense weave or both, since the thermoplastic material will take up some of the load. This results in a lighter weight fabric.

In spite of the apparent advantages of speed and low cost, adhesion of the extruded coating to high tenacity yarn fabrics is sometimes difficult. The extrusion coating described hereinafter provides good adherence, good surface finish and resistance to heat and pressure.

In the parent application (now U.S. Pat. No. 5,763,330) it was recognized that a nylon extrusion coated, linear low density polyethylene fabric with a tie layer of anhydride modified ethylene vinyl acetate (EAA), alone or with acid modified vinyl acrylate (EVA) provided an air bag fabric with a tear strength of greater than 50 pounds when the coated fabric weight was just less than 5.5 oz/yd². Since that time it has been discovered that other thermoplastics such as polyester and polypropylene and others, and other extrusion coatings such as other polyethylenes, polyurethane, nylon, polyester, polypropylene and blends thereof also form air impermeable fabrics such as are used for airbags. Further, the coatings can be applied to form fabric weights in the range of up to 7.5 oz/yd², while achieving considerably higher tear strengths (8-10 pounds of tear strength force per each oz/yd² of fabric weight).

### SUMMARY OF THE INVENTION

The present invention is directed to airbag fabrics that are formed of a substrate of high tenacity yam such as nylon, polyester, polypropylene or the like with an extrusion coating of a thermoplastic material. Because of the extrusion coating, these fabrics may be made of lower denier yarns with a less dense weave. For example, high tenacity yarns formed of deniers in the range of 210 to 660 may be woven with warp and fill densities of 30 to 70 ends per inch. For example, a 420 denier fabric, when coated according to the present invention, will result in fabrics having a tear strength to weight ratio of about 10# per oz per yd². As a more specific example, a 4.4 oz/yd² fabric made of 210 denier yarns and coated according to the present invention should achieve a tear strength of almost 40#. High tenacity yarns, i.e., those with a tenacity greater than 5 grams/denier, along with the extrusion coating, permit the resulting fabric to exhibit a high strength to weight ratio. This is extremely important in fabrics used in air bags and the like. When provided with an extruded thermoplastic coating, compatible to the fabric material, these lighter weight fabrics become lightweight and air impermeable. By properly selecting the yam and coating, the fabric can be recyclable. Air impermeability is defined as less than 0.3 cfm/ft² at 0.5 in water pressure (125 Pascals).

To form fabrics of the present invention, an extrusion coating head located between the supply roll and the take-up roll, applies a thermoplastic coating onto one surface of the length of fabric. A combining roll located between the supply roll and the take-up roll and adjacent to the extrusion coating head joins the extrudable thermoplastic coating to one surface of the length of fabric. The combining roll is preferably heated to provide improved adhesion of the extruded thermoplastic coating onto the surface of the length of fabric.

The resulting fabric has a tear strength, when tested according to ASTM D1682, in the range of 10-70 pounds and a weight, when tested according to ASTM 5041, in the range of up to 7.5 oz. per sq. yd. Further, the coating makes the fabric substantially air impermeable to gases [less than 0.3 cfm/ft² at 0.5 in water pressure (125 Pascals)]. The coating also serves to fix the yarns to each other enhancing fabric stability.

One aspect of the present invention is to provide a low cost, recyclable fabric with a high strength to weight ratio formed of high tenacity yarns including but not limited to nylon, polyester, polypropylene, and like yarns extrusion coated with a thermoplastic coating. Suitable coatings include olefins such as linear low density polyethylene plastic (LLDPE), and other polyethylenes, polypropylenes and blends thereof; polyurethane; nylon; polyesters; and blends thereof. Where, necessary a tie layer is provided between the substrate and the coating.

Another aspect of the present invention is to provide a method for manufacturing a low cost, recyclable fabric for airbags by extrusion coating the thermoplastics listed above onto fabric substrates of the aforesaid high tenacity yarns. The method includes the steps of: (a) supplying a length of fabric formed from high tenacity yarns having a top and bottom surface from a supply roll; (b) taking up the length of fabric onto a take-up roll; (c) applying the extrudable thermoplastic coating onto one surface of the length of fabric through an extrusion coating head, the head being located between the supply roll and the take-up roll and extending transverse to the movement of the length of the fabric; and (d) joining the extruded thermoplastic coating to the one surface of the length of fabric by utilizing a combining roll located between the supply roll and the take-up roll and adjacent to the extrusion coating head, wherein the combining roll is heated to provide improved adhesion of the thermoplastic coating onto the surface of the length of fabric.

Still another aspect of the present invention is to provide a low cost, recyclable fabric having a strength to weight ratio in excess of that achieved by conventional rubber coated fabric.

These and other aspects of the present invention will become apparent to those skilled in the art after a reading of the following description of the preferred embodiment when considered with the drawings.

### BRIEF DESCRIPTION OF THE DRAWINGS

FIG. 1 is a front schematic view of an extrusion-coating machine constructed according to the present invention;

FIG. 2 is a side schematic view of the extrusion-coating machine shown in FIG. 1;

FIG. 3 is a cross-sectional view of an airbag fabric produced according to the present invention; and

FIG. 4 is a graph comparing tear strength of solvent coated and extrusion coated fabrics.

### DESCRIPTION OF THE PREFERRED EMBODIMENTS

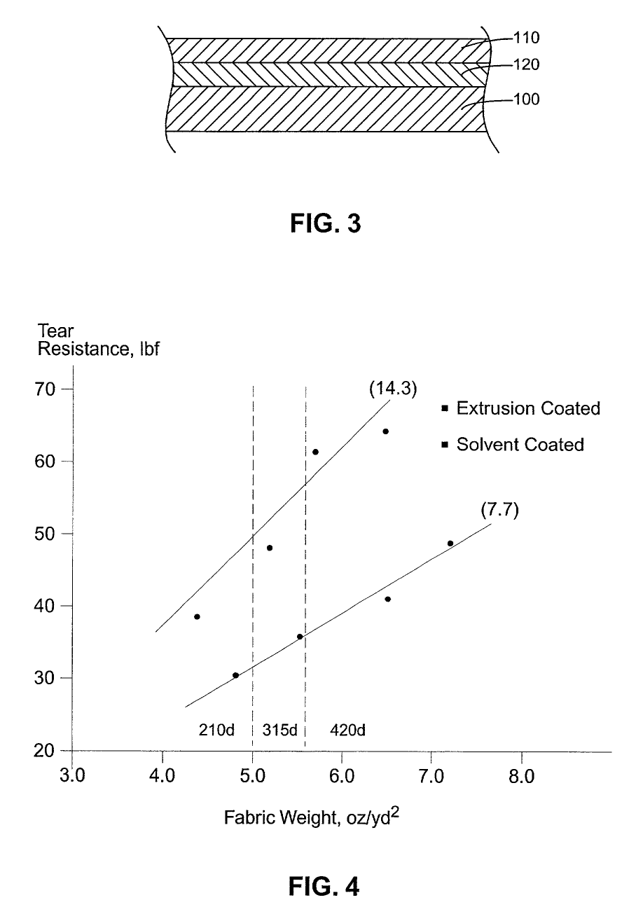

Referring now to the drawings, and particularly to FIG. 3, there is illustrated the product of the present invention. In general, the product includes a fabric substrate 100 formed of high tenacity thermoplastic yarns (>5 grams/denier) and a thermoplastic coating 110. Examples of such yarns include nylon, polyester, polypropylene, and the like. Thermoplastic coatings include olefins such as linear low-density polyethylene (LLDPE) and other polyethylenes and polypropylenes and blends thereof, polyurethane, nylon, polyester, or blends thereof. The coating must be extrudable and adhere to the substrate. Some coatings are inherently compatible with some substrates and will adhere without a tie layer 120. However, other coatings do not adhere extremely well to the substrate and need a tie layer 120. For example, such materials as anhydride modified ethylene vinyl acetate (EAA) and acid modified ethylene vinyl acrylate polymer (EVA) perform well as a tie layer for olefin coatings applied to nylon or polyester substrates. On the other hand, when the substrate is polypropylene a tie layer is generally not required for olefin coatings, as polypropylene is itself an olefin. Similarly, nylon coatings would inherently adhere to nylon fabrics and polyester coatings would adhere to polyester substrates.

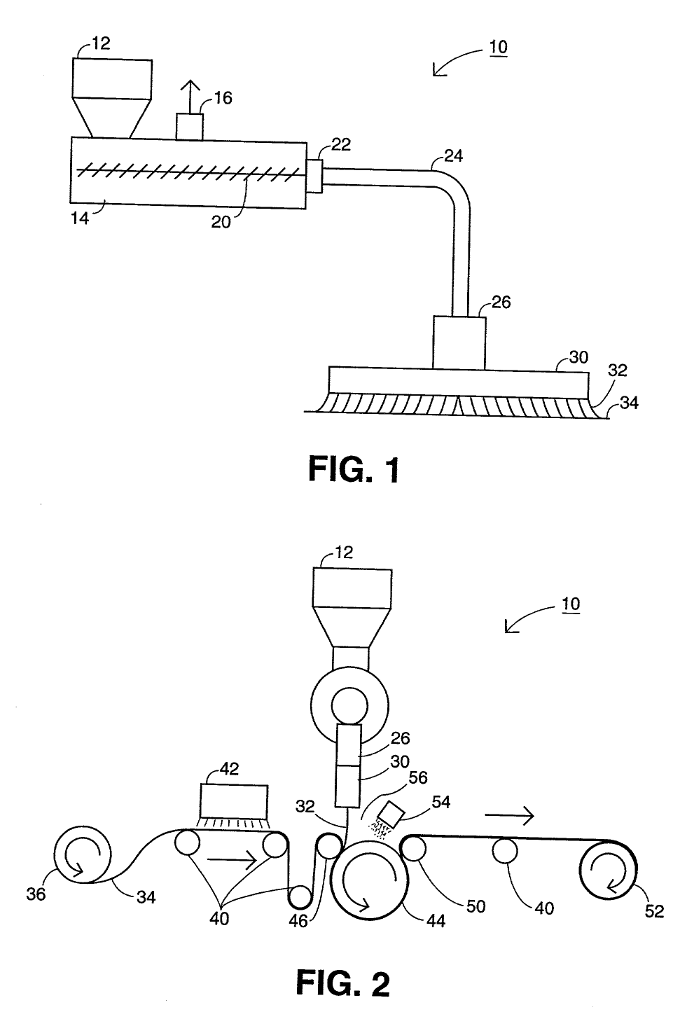

An extrusion-coating machine, generally designated 10, is shown in FIG. 1. The machine 10 is designed to process coated fabric according to the present invention. The extrusion-coating machine 10 is of a conventional design, such as a Battenfeld Gloucester/Rotomec America Rotocoat Extruder 1220/100, having a resin hopper/dryer 12 for introducing resin into melt zone 14 of the extruder. A vacuum source 16 devolatilizes the resin as it melts. An extruder 20 forces the melted resin through a diehead 22 and a melt pipe 24. Melt pipe 24 is connected to a feed block 26 that is attached to diehead 30. Diehead 30 spreads out the melt curtain 32 onto the rapidly moving substrate 34 underneath the melt curtain.

As best seen in FIG. 2, there is shown a side elevational view of the extrusion coating machine 10 shown in FIG. 1. Extrusion coating machine 10 also includes a substrate supply roll 36 for supplying the substrate 34 to the extruder 10A. Plurality of rollers 40 convey the substrate 34 to the extruder 10. In the preferred embodiment, a pretreatment zone 42, consisting of a corona discharge or flame pretreatment prepares one surface of the substrate 34 to receive the extrusion coating. A large roller combines the substrate 34 and the melt curtain 32 with the aid of pinch rollers 46 and 50. A take-up roll 52 receives the combined coated substrate 38.

Unlike the prior art, in which roller 44 is normally chilled, in the present invention it has been found that it is necessary to heat roll 44 up to about >180° F. for proper adhesion. In addition, pull-off preferably is further improved to prevent sticking to the roll by the addition of a water mister 54 which coats the surface of heated roll 44 as the melt curtain and substrate are combined. However, it was found that the water mister 54 was only effective in combination with the heated roll. Finally, it has been found that both the air gap 56 and angle 58 where the melt curtain contacts the substrate and heated roll 34 are critical. Specifically, air gap 56 should be between about 1 and 2 inches. In addition, the angle of incidence 58 should be between about 45° and 75°.

The above-described extrusion coating machine 10, shown in FIGS. 1 and 2, is especially useful in creating the present invention; namely, coated fabrics that contain high tenacity yarns, which by definition defined as yarns with a tenacity of greater than 5 grams/denier. Examples of substrate fabrics include nylon, polyester, polypropylene and the like. Substrate fabrics are chosen for their high strength to weight ratio. The extrudable thermoplastic may be any compatible extrudable thermoplastic. Examples include olefins such as LLDPE other polyethylenes and polypropylene, polyurethane, nylon, polyester or blends thereof.

With specific reference to extrusion coating a nylon fabric, it has been found that the application of a top layer of linear low density polyethylene plastic (LLDPE) onto a bottom layer of non-olefinic fabric produces an extrusion coated fabric having only moderate adherence. It may be necessary, therefore, to use a compatible tie layer between the substrate and the coating to further improve adhesion. This is also true where the fabric and coating properties are different. Unless the fabric and coating are both olefins, both polyester, or both nylon, the tie layer is preferable.

In one embodiment of the present invention, an extruded tie layer of an anhydride modified ethylene vinyl acetate (EAA) having a VICAT softening point of less than about 100° C. is used between the nylon substrate and the LLDPE coating. One disadvantage, however, in using most tie layers having a VICAT of less than 100° C. is that very severe sticking problems can occur when coating nylon fabrics. This is true for EAA. Such problems occur because the tie layer actually penetrates the fabric and exits out of the opposite surface. On the other hand, a tie layer with a VICAT of greater than about 100° C. also presents certain problems. Acid modified ethylene vinyl acrylate polymer (EVA) for example, produces an unstable melt curtain that does not produce a satisfactory finish.

By blending EVA and EAA, a tie layer is produced that will not penetrate so far as to stick, while providing a stable melt curtain. About 15 wt % EVA having a higher VICAT is combined with about 85 wt % EAA having a lower VICAT. Similar results can be achieved with a blend of between about 5 wt % and about 55 wt % EVA having a higher VICAT and between about 45 wt % and 95 wt % EAA having a lower VICAT.

The EVA of the present invention is preferably 2022 extrudable adhesive resin, available under the tradename BYNEL from E.I. DuPont of Wilmington, Del. The EAA of the present invention is preferably 3990 extrudable adhesive resin available under the tradename BYNEL from E.I. DuPont of Wilmington, Del. Other tie layers may be utilized for other combinations of fabric and coatings as indicated below.

TABLE 1

| EXAMPLE | SUBSTRATE | COATING | TIE LAYER |
|---|---|---|---|
| 2 | Nylon | Polyurethane | Reactive coupling agent |
| | | | such as isocyanate |
| | | | or epoxy |
| 3 | Nylon | Olefinic (TPO) | EAA and EVA |
| 4 | Polyester | Polyurethane | Reactive coupling agent |
| | | | such as an isocyanate |
| | | | or epoxy |
| 5 | Polyester | Olefinic (TPO) | EAA and EVA |
| 6 | Polypropylene | Olefinic (TPO) | None |
| 7 | Polypropylene | Polyurethane | Maleic anhydride modi- |
| | | | fied polypropylene |

FIG. 3 shows a cross-sectional view of an airbag fabric produced according to the present invention. The resulting airbag fabric has a nylon substrate with an LLDPE top coating of between about 0.0005 and 0.0007 inches and preferably about 0.0006 inches. The EAA or EAA/EVA tie layer coating preferably is between about 0.003 and 0.0004 inches and preferably about 0.0003 inches.

There is shown a graphical representation of the physical characteristics of the airbag fabric according to the present invention. As shown in FIG. 4, the tear strength of the coated fabric, when tested according to ASTM D1682, is between about 20 and 60 pounds and, preferably is greater than about 50 pounds. The weight of the coated fabric when tested according to ASTM 5041, is between about 2 and 7.5 oz. per sq. yd. while, at the same time, the tear strength in pounds/oz (strength-to-weight ratio) remains at about 8-10 pounds/oz.

The advantages of the present invention can be best understood by a review of the following examples:

### EXAMPLES

For purposes of the tests illustrated in FIG. 4, coated nylon fabrics were prepared at weights between about 4 and 7 oz. per sq. yd. using conventional solvent processes and the extrusion coating process with the tie layer as described above. The tear strength of the coated fabrics were then tested according to ASTM D1682. The results are shown in Table 2, below:

TABLE 2

| SOLVENT COATED | | | | EXTRUSION COATED | | | |
|---|---|---|---|---|---|---|---|
| Construction | | | | Construction | | | |
| | Ends/ | | | | Ends/ | | |
| | Pick | | Tear | | Pick | | Tear |
| | Per | Wt. | Strength | | Per | Wt. | Strength |
| Denier | Inch | (oz/yd²) | Lbs. | Denier | Inch | (oz/yd²) | Lbs. |
| 210 | 70 | 4.8 | 30.7 | 210 | 64 | 4.4 | 39.6 |
| 315 | 50 | 5.5 | 35.8 | 315 | 50 | 5.2 | 48.4 |
| 420 | 46 | 6.4 | 41.2 | 420 | 42 | 5.7 | 62.8 |
| 420 | 48 | 7.2 | 49.4 | 420 | 46 | 6.5 | 66.1 |

In addition, the coated fabric produced according to the present invention still had an increased crease flex test value of about grade 4, when tested according to SM5 4-3-8, and was air impermeable as defined as less than 0.3 cfm/ft² at 0.5 in water pressure (125 Pascals).

Certain modifications and improvements will occur to those skilled in the art upon a reading of the foregoing description. By way of example, it is contemplated that the extrusion coated fabric may be further enhanced by treating the fabric with additives or additional processes during the extrusion step. It should be understood that all such modifications and improvements have been deleted herein for the sake of conciseness and readability but are properly within the scope of the following claims.

We claim:

1. An airbag fabric being substantially air impermeable and comprising a fabric substantially formed of yarns having a tenacity greater than 5 grams/denier and an extrusion coating of thermoplastic material selected from the group consisting of linear low density polyethylene, other polyethylenes, polyurethane, nylon, polypropylene, polyester, and blends thereof, said coated fabric having a tear strength, when tested according to ASTM D1682 in excess of that achieved by conventional solvent coated fabrics.

2. The airbag fabric according to claim 1, wherein said fabric layer is formed of yarns selected from the group consisting of nylon, polyester, and polypropylene.

3. The airbag fabric according to claim 2 and further including a tie layer between said fabric and said coating, said tie layer selected from the group consisting of anhydride modified ethylene vinyl acetate, a blend of anhydride modified ethylene vinyl acetate and acid modified ethylene vinyl acrylate, isocyanate, epoxy, and maleic anhydride modified polypropylene.

4. An airbag fabric being substantially air impermeable and comprising a woven fabric substrate formed of yarns selected from the group consisting of polyester, polypropylene, and blends of nylon, polyester and/or polypropylene and an extrusion coating of a material selected from the group consisting of linear low density polyethylene, other polyethylenes, or polyurethane, nylon, olefins, polyester, and combinations thereof, said coated fabric having a tear strength, when tested according to ASTM D1682 in excess of that achieved by conventional solvent coated fabrics.

5. The airbag fabric according to claim 4 and further including a tie layer between said fabric and said coating, said tie layer selected from the group consisting of anhydride modified ethylene vinyl acetate, a blend of anhydride modified ethylene vinyl acetate and acid modified ethylene vinyl acrylate, isocyanate, epoxy, and maleic anhydride modified polypropylene.

6. The airbag fabric according to claim 2 wherein said fabric substrate is formed of nylon yarns, said extruded coating is polyurethane, and further including a tie layer of isocyanate.

7. The airbag fabric according to claim 2 wherein said fabric substrate is formed of nylon yarns, said extruded coating is polyurethane, and further including a tie layer of epoxy.

8. The airbag fabric according to claim 4 wherein said fabric substrate is formed of polyester yarns, said extruded coating is polyurethane, and further including a tie layer of isocyanate.

9. The airbag fabric according to claim 4 wherein said fabric layer is formed of polyester yarns, said extruded coating is polyurethane, and further including a tie layer between said fabric and said coating, said tie layer is epoxy.

10. The airbag fabric according to claim 4 wherein said fabric substrate is formed of polyester yarns, said extruded coating is an olefin, and further including a tie layer of a blend of EAA and EVA.

11. The airbag fabric of claim 4 wherein said fabric substrate is formed of polypropylene yarns and, said extruded coating is an olefin.

12. The airbag fabric of claim 4 wherein said fabric substrate is formed of polypropylene yarns, said extruded coating is polyurethane, and the tie layer is maleic anhydride modified polypropylene.
